(19) United States
(12) Patent Application Publication
(10) Pub. No.: US 2010/0024621 A1
(43) Pub. Date: Feb. 4, 2010

(54) Saw Table and Power Saw Combination

(75) Inventors: Jeffrey Van Cleave, Troy, MI (US); Eugene G. Eichhorn, Pinckney, MI (US); Matthew S. Damron, Ypsilanti, MI (US); Joseph W. Pawlow, Redford, MI (US)

Correspondence Address: BROOKS KUSHMAN P.C., 1000 TOWN CENTER, TWENTY-SECOND FLOOR, SOUTHFIELD, MI, 48075, US

(73) Assignee: VAN MARK PRODUCTS CORPORATION, Farmington Hills, MI (US)

(21) Appl. No.: 12/183,203

(22) Filed: Jul. 31, 2008

(51) Int. Cl. B26D 7/00

(52) U.S. Cl. 83/471.2

(57) ABSTRACT

A saw table having a boom on which a circular saw is received is disclosed. The boom includes adjustably secured track rails that directly engage a sole plate of the saw. The saw may be inserted between the track rails in either a transverse or longitudinal orientation. The track rails are supported in a spaced relationship relative to a track base. An access opening is formed in an upper flange of at least one track rail at one end of the track rail. The saw is inserted through the access opening and moved along the boom until it is fully retained between upper and lower flanges of both of the right and left track rails.

### BACKGROUND OF THE INVENTION

1. Field of the Invention

The present invention relates to a saw table that directly receives a power saw.

2. Background Art

Fabricating a building product at a job site often requires cutting building components to a specific length. The cut may be square or at a mitered angle. A portable circular saw is frequently used for such cutting. Accurate cutting often requires mounting the saw to a fixture such as a saw table.

In addition, different building products require different cutting blades. For example, wood may cut with the grain using a ripping blade or across the grain with a fine-toothed blade. Cement board and fiberglass products may need a carbide coated blade. Therefore, multiple powered saws, each having a specialized blade, may need to be interchanged quickly on the saw table.

Portable saw tables may have a saw track assembly that includes a pair of guide rails for supporting and guiding the circular saw while cutting a workpiece. Guide rails are often categorized as either an open rail design or a closed rail design. Open rail designs allow quick mounting and dismounting of the circular saw. Either gravity or downward pressure on the saw is relied upon to keep the saw seated on the rails during cutting operations. Closed rail designs often use a mounting plate for attaching the saw to the guide rails. Mounting plates are complex and time consuming to use. The saw must be semi-permanently affixed to the mounting plate which is, in turn, attached to the saw table. Attaching the saw to the mounting plate negates the portability advantage of the saw. In addition, some saw tables have a square mounting plate that is used to retain the sole plate of the saw. The square mounting plate is rotated 90° to convert from a rip cut position to a cross-cut position.

There is a long felt need for a saw table that allows almost any saw to be readily attached to the saw table in a fully captured manner without requiring attachment to a mounting plate.

The above problems and needs are addressed by the invention as summarized below.

### SUMMARY OF THE INVENTION

According to one aspect of the present invention a saw table is provided that directly receives a power saw. The combination includes a work table defining a work surface and a boom that is pivotally secured to the work table. The boom has opposed rails that are spaced apart to guide the saw. The rails define a retention structure. The saw includes a sole plate having a top surface. The retention structure directly engages the sole plate's top surface to prevent inadvertent removal of the saw from the boom. The rails also define an access opening through which the sole plate of the saw is inserted and removed from the retention structure.

In another embodiment of the invention, a saw table is provided for a power saw that has a rectangular sole plate. A boom is secured to the work table that pivots about an axis that is substantially perpendicular to the work surface. The boom has opposed rails that are spaced apart to guide the saw and define elongated channels that engage the sole plate. The channels prevent upward removal of the saw from the boom along the majority of the length of the boom. At least one channel has a cut out that defines an upward access opening through which the rectangular sole plate of the saw may be pivotably disengaged from the boom.

According to other features of the saw table, the boom has a base that is capable of pivoting from 0 to 90° about an axis that is substantially perpendicular to the work surface. The boom has a track defined by opposed rails that are raised above the base of the boom. The rails comprise opposed elongated C-channels having a flange. The C-channels engage the sole plate to prevent removal of the saw from the boom. At least one rail defines an upward access opening at a cut out of the flange along a limited portion of the length of the rail. The cut out directly receives the sole plate when the rails are spaced apart to properly guide the saw.

### BRIEF DESCRIPTION OF THE DRAWINGS

FIG. 1 is a perspective view of a saw table and saw illustrating one embodiment of the present invention;

FIG. 2 is an exploded perspective view of the saw table shown in FIG. 1;

FIG. 3 is an end elevation view of a track rail and cam lock assembly shown assembled to a track base in the unlocked position;

FIG. 4 is an end elevation view of a track rail and cam lock assembly shown assembled to a track base in the locked position;

FIG. 5 is a fragmentary partially exploded perspective view of one end of a boom of the saw table;

FIG. 6 is a perspective view of a saw and boom showing the saw being inserted into an access opening in the boom;

FIG. 7 is a perspective view of the saw after insertion into the access opening on the boom;

FIG. 8 is a perspective view of the saw and boom with the saw retained by the boom;

FIG. 9 is a fragmentary side elevation view of a saw attached to one end of the boom with the saw in a raised position;

FIG. 10 is a fragmentary side elevation view of a saw attached to one end of the boom with the saw in its lowered, or cutting, position;

FIG. 11 is a fragmentary perspective view showing the saw installed in the boom for a rip cutting operation; and

FIG. 12 is a fragmentary perspective view of an alternative embodiment of the saw table boom.

### DETAILED DESCRIPTION OF THE ILLUSTRATED EMBODIMENTS

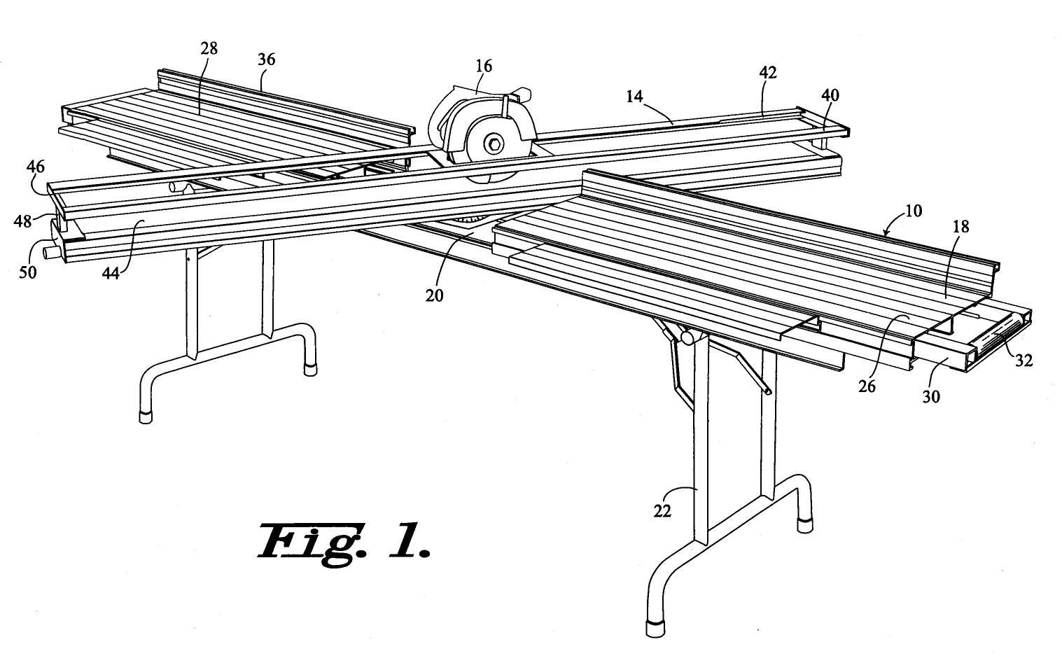

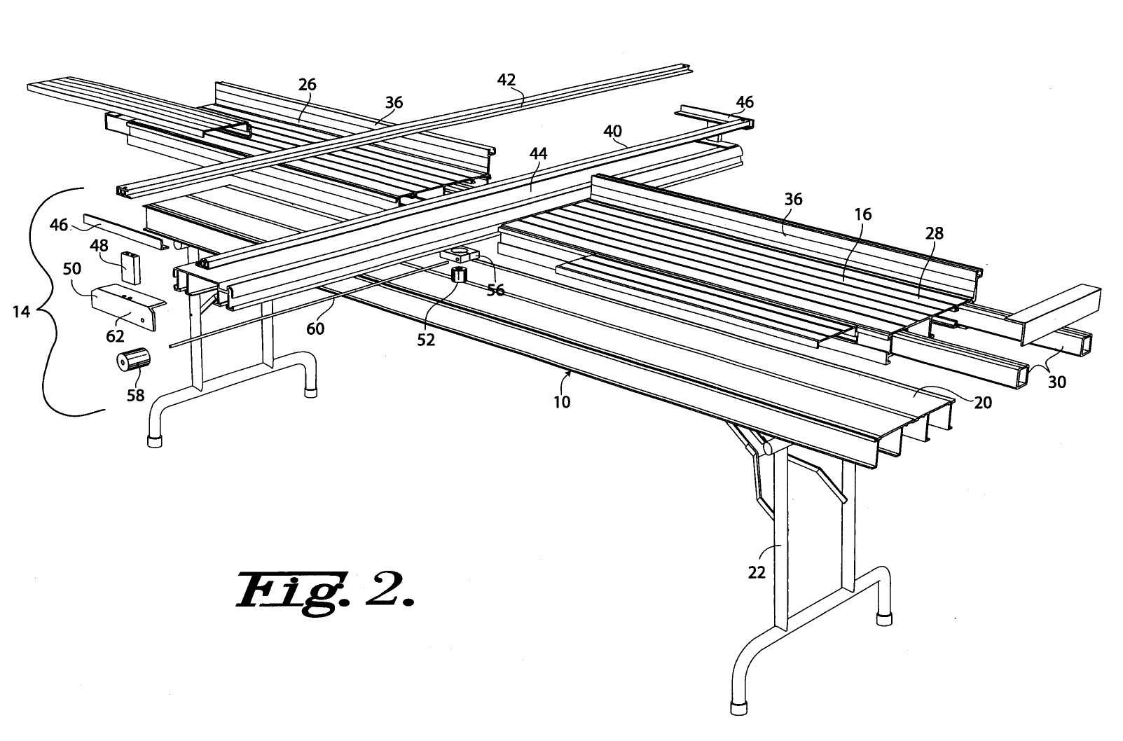

Referring to FIGS. 1 and 2, a saw table is generally indicated by reference numeral 10. The saw table 10 includes a boom 14 to which a circular saw 16 is directly and removably attached. The saw table includes a top deck 18 that is slidably secured to a support deck 20. The support deck 20 may be provided with a pair of legs 22 that support the saw table when in use.

The top deck 18 of the saw table 10 is split into a right portion 26 and a left portion 28 that slide together and apart on opposite sides of the boom 14. A pair of tubular extension rails 30 are slidably received in the support deck 20. A roller 32 is rotatably supported by the extension rails 30 to facilitate movement of work pieces onto and off of the top deck 18. A split fence 36 is attached to the back side of the top deck 18 and moves with the right and left portions 26, 28 of the top deck 18.

The boom 14 includes a right track rail 40 and a left track rail 42 that are secured to a track base 44. The rails 40, 42 are secured to the track base 44 by track cross bars 46 located on opposite ends of the rails 40, 42. The cross bars 46 are held in a spaced relationship relative to the track base 44 by a track riser 48. A track end piece 50 is assembled to the end of the track base 44 to close off and finish the ends of the track base 44. A pivot stub shaft 52 is secured to the top of the support deck 20 and is received in a split pivot block 56. The split pivot block 56 is assembled to the bottom of the track base 44. The boom 14 pivots on the pivot stub shaft 52 within the split pivot block 56. An adjustment knob 58 is secured to a lock rod 60 that extends through a hole 62 in the track end piece 50 and also to the split pivot block 56. The adjustment knob 58 is rotated to tighten or loosen the split pivot block 56 on the pivot stub shaft 52. The adjustment knob 58 is used to loosen the clamping force applied by the split pivot block 56 to the stub shaft 52 to allow the boom 14 to be moved from a cross-cut position through a full range of miter positions.

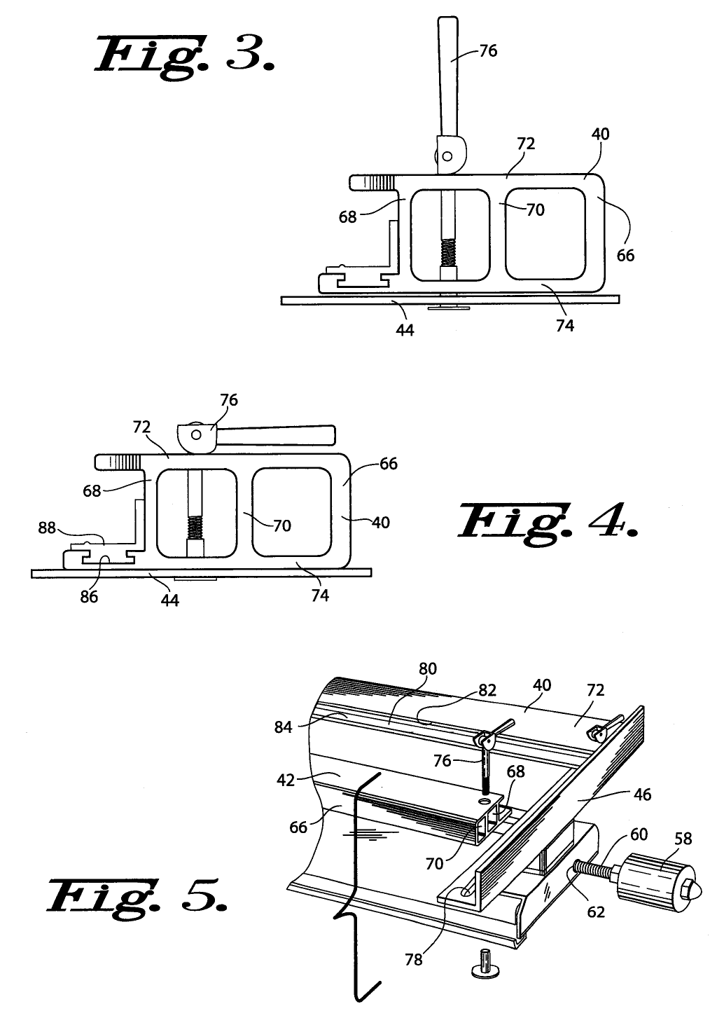

Referring to FIGS. 3-5, the structure of the track rails will be described with reference to the right track rail 40. However, it should be understood that the left track rail 42 is essentially a mirror image of the right track rail and will not be separately described to avoid redundancy. The right track rail 40 is secured to the track base 44. The track rail 40 includes an outer wall 66, an inner wall 68 and a reinforcing rib 70. The walls 66, 68 and reinforcing rib 70 extend between a top wall 72 and a bottom wall 74. The track rail 40 is preferably formed in an extrusion process and may be an aluminum extrusion, but could also be formed of other extrudable materials such as plastic or magnesium. The track rail 40 is secured to the track base 44 by a cam lock assembly 76. As shown in FIG. 3, the cam lock assembly 76 is in an unlocked position, while in FIG. 4 the cam lock assembly 76 is shown in its locked position. Referring to FIG. 5, a slot 78 is provided in the track cross bar 46. The slot may extend the full length of the track cross bar 46 or may be provided in two segments, one for each of the track rails 40, 42. When the cam lock assembly 76 is unlocked, the track rails 40, 42 may be moved together or apart to accommodate saws of different sizes.

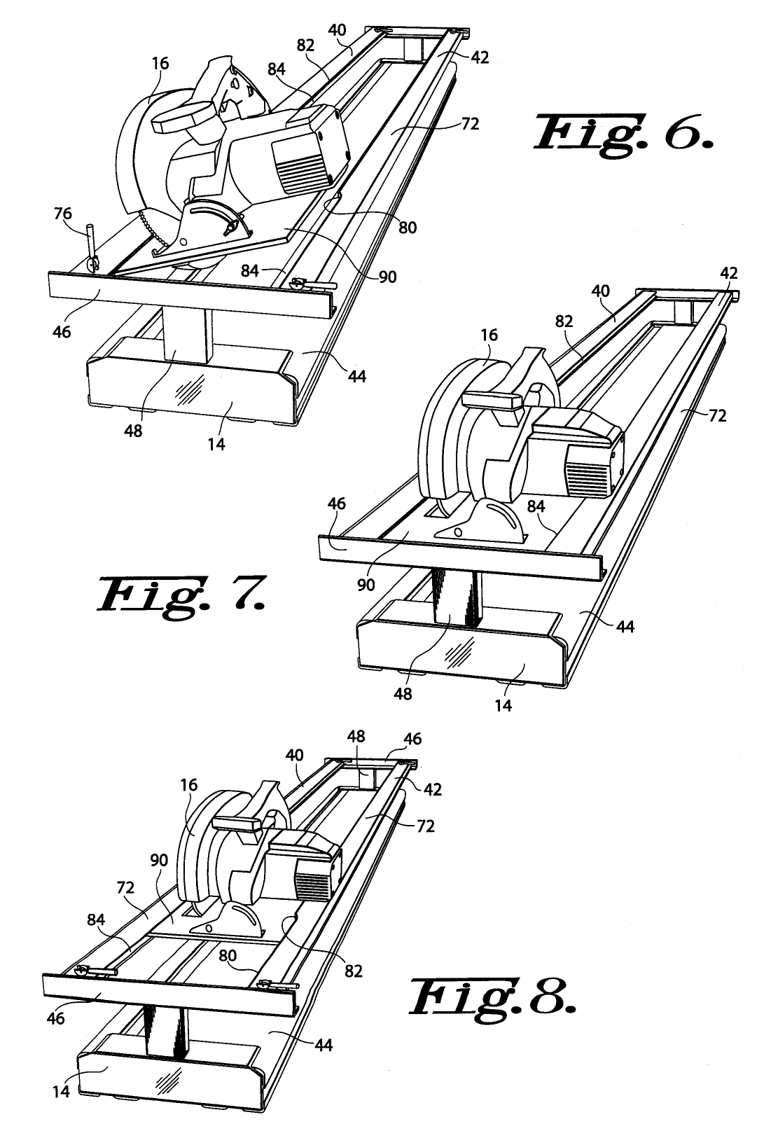

Referring to FIGS. 6-8, the procedure for assembling a saw 16 to the boom 14 is described in greater detail. As shown in FIG. 6, the saw 16 is positioned over an access opening 80 formed in the left track rail 42. It should be understood that the access opening 80 could be provided in either or both of the track rails 40, 42. The track rails 40, 42 each include an upper flange 82 and a lower flange 84 that are extensions of the top wall 72 and bottom wall 74, respectively.

Referring to FIGS. 3 and 4, an inverted T-slot 86 may be provided in the lower flange 84. Vinyl slide inserts 88 may be installed in the inverted T-slots 86 to facilitate moving the saw 16 within the boom 14.

Referring again to FIGS. 6-8, the saw 16 includes a sole plate 90 that is inserted between the upper and lower flanges 82 and 84 of the right track rail 40. The opposite side of the sole plate 90 is poised over the access opening 80 in FIG. 6. In FIG. 7, the saw has been pivoted into the access opening 80 and is aligned with the upper and lower flanges 82, 84 of the left track rail 42. Referring to FIG. 8, the saw 16 is shown captured between the upper and lower flanges 82 and 84 of both of the right and left track rails 40, 42. It will be appreciated that in this position, the saw 16 is fully captured on the boom 14. The saw 16 cannot be lifted off of the boom 14 and is held in the proper spaced relationship relative to a workpiece and the track base 44.

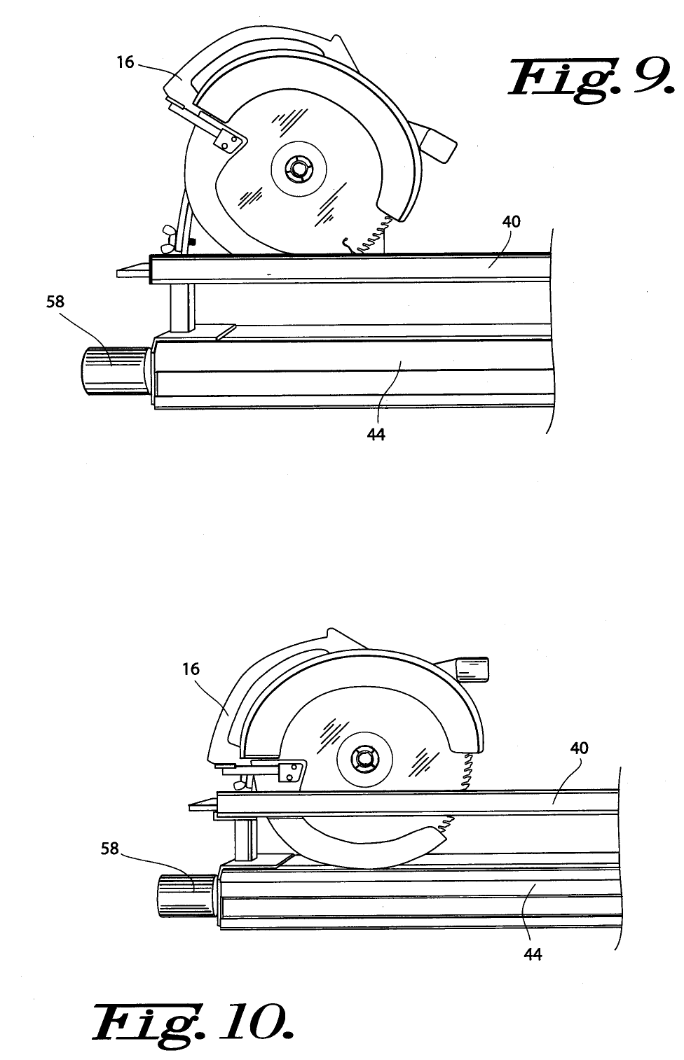

Referring to FIGS. 9 and 10, the saw is shown in a raised position in FIG. 9 and in a lowered, or cutting, position in FIG. 10. In FIG. 9, the saw blade is pivoted upwardly by the saw 16. In this position, a workpiece may be moved under the track rails 40 and 42. Prior to cutting, the saw blade is lowered relative to the track rail 40 until it is positioned at the desired height relative to the track base 44. The adjustment knob 58 that is used to release and lock the boom at the proper cutting angle is shown extending from the track base 44.

Referring to FIG. 11, the boom 14 is shown with the saw 16 assembled to the boom 14 in the orientation for rip cutting a workpiece 92. In this position, the saw 16 is locked between the right and left track rails at the desired distance from the fence 36. The fence 36 guides one end of the workpiece 92 as the workpiece 92 is moved into the saw 16 to be ripped to the proper width. The procedure for inserting the saw 16 between the track rails 40 and 42 is the same as the procedure described with reference to FIGS. 6-8 above, but the saw is rotated 90°. Since the sole plate 90 is not normally square, it may be necessary to readjust the spacing between the track rails 40, 42 by releasing the cam lock assembly 76 on opposite ends of the track rail to permit the track rails to be moved apart or together to firmly secure the sole plate 90 between respective upper and lower flanges 82, 84.

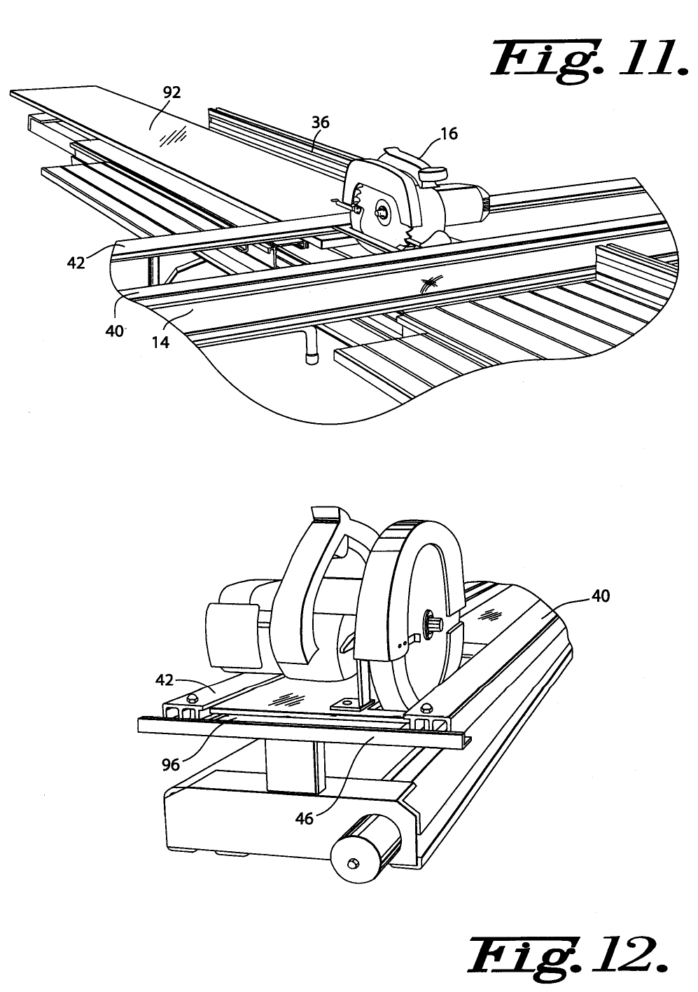

Referring to FIG. 12, an alternative embodiment is shown in which an access opening 96 is defined between the right and left track rails 40, 42. In the illustrated embodiment, the height of the track cross bar 46 is reduced to allow the sole plate 90 of the saw 16 to be inserted between the track bars 40, 42 and over the cross bar 46. The access opening 96 could be selectively closed or blocked by a gate (not shown).

While embodiments of the invention have been illustrated and described, it is not intended that these embodiments illustrate and describe all possible forms of the invention. Rather, the words used in the specification are words of description rather than limitation. It is understood that various changes may be made without departing from the spirit and scope of the invention.

What is claimed is:

1. A saw table and power saw in combination, the saw having a sole plate including a top surface, the combination comprising:
a work table defining a top deck; and
a boom secured to the work table, the boom selectively pivots about a pivot axis which is substantially perpendicular to the top deck, the boom has a pair of opposed rails that are spaced apart to guide the saw, the rails further define a retention structure that directly engages the top surface of the sole plate to prevent removal of the saw from the boom, wherein at least one of the rails define an access opening through which the sole plate of the saw passes to insert and remove the saw from the retention structure.

2. The combination of claim 1 wherein the retention structure includes a flange formed on each of the rails that extends along the length of the rails, and wherein the first access opening is defined by a cut out in one of the flanges along a limited portion of the length of the rail.

3. The combination of claim 2 wherein the rails comprise a channel having a top wall and a bottom wall that are connected by a plurality of walls, wherein the top side includes the flange.

4. The combination of claim 2 wherein the sole plate of the saw engages one rail, wherein the sole plate pivots on the one rail and passes through the cut out in the flange of the opposite rail to insert and remove the saw from the retention structure.

5. The combination of claim 1 wherein the sole plate is rectangular, the work table has a first longitudinal axis and the boom has a second longitudinal axis, wherein the spacing of the rails may be changed to capture the saw with the blade oriented to cut in line with the longitudinal axis of the table while the longitudinal axis of the boom is perpendicular to the longitudinal axis of the table to rip saw a workpiece.

6. A saw table and power saw in combination, the saw having a rectangular sole plate having a top surface, the combination comprising:
a work table defining a work surface having a first longitudinal axis; and
a boom contacting the work table and having a second longitudinal axis, the boom selectively pivots about a pivot axis that is substantially perpendicular to the work surface, the boom has a track base and a pair of opposed rails that are spaced apart to receive the saw, the rails defining opposed elongated channels that engage the top surface of the sole plate to prevent upward removal of the saw from the boom, wherein at least one rail has a cut out that defines an access opening through which the rectangular sole plate of the saw is pivoted while engaging the other rail to insert and remove the saw from the boom.

7. The combination of claim 6 wherein the channels comprise a flange extending essentially the length of the rail, and wherein at least one portion of one of the flanges defines the cut out in the flange.

8. The combination of claim 6, wherein each channel comprises a flange wherein at least one of the flanges define the cut out in the rail.

9. The combination of claim 6 wherein the work surface has a first longitudinal axis and the boom has a second longitudinal axis, wherein the spacing of the rails may be changed to capture the saw with the blade oriented to cut in line with the longitudinal axis of the table while the longitudinal axis of the boom is perpendicular to the longitudinal axis of the table to rip saw a workpiece.

10. A saw table and power saw in combination, the saw having a sole plate, the combination comprising:
a work table defining a work surface on which a work piece may be received; and
a boom secured to the work table, the boom having a track base that pivots from 0 to 90° about an axis that is substantially perpendicular to the work surface, the boom having a pair of opposed rails that are spaced apart to guide the saw and are raised above the track base of the boom, a portion of the rails comprise opposed elongated C-channels having a flange, the C-channels engage the sole plate to prevent removal of the saw from the boom, wherein the pair of rails define an access opening between the rails at one end of the rails through which the sole plate of the saw may be inserted and removed.

11. The combination of claim 10 wherein the work table is divided into two portions, the portions being movable relative to a support deck, wherein the boom is assembled by a selectively locked pivot connection between the two portions.

12. The combination of claim 11 wherein the work table has a fence on one edge that is split between the two portions of the work table, wherein the two portions of the work table and the fence are separated to provide clearance for the boom to pivot.

13. The combination of claim 10 wherein the rails each have a top wall and a bottom wall that are connected by an outer wall and an inner wall, wherein the flange of the C channel is part of the top wall that extends inwardly from the inner wall.

14. The combination of claim 13 further comprising a reinforcing rib extending between the top wall and the bottom wall at an intermediate location between the inner wall and the outer wall.

15. The combination of claim 13 further comprising a lower flange of the C channel as part of the bottom wall that extends inwardly from the inner wall.
